(19) United States
(12) Patent Application Publication
(10) Pub. No.: US 2015/0356929 A1
(43) Pub. Date: Dec. 10, 2015

(54) DISPLAY DEVICE FOR CORRECTING DISPLAY NON-UNIFORMITY

(71) Applicant: Jinfeng ZHAN, Suwon-si (KR)

(72) Inventor: Jinfeng ZHAN, Suwon-si (KR)

(21) Appl. No.: 14/620,417

(22) Filed: Feb. 12, 2015

(30) Foreign Application Priority Data
Jun. 10, 2014 (KR) 10-2014-0070357

(51) Int. Cl. G09G 3/34

(52) U.S. Cl. CPC G09G 3/3413; G09G 2360/147; G09G 2320/0271; G09G 2320/0295; G09G 2320/0233

(57) ABSTRACT

A display device including a panel including a plurality of pixels, and a non-uniformity correction unit configured to perform interpolations with regard to different pixels in multiple stages to correct non-uniformity of the pixels may be provided. Further, a display device including a panel including a plurality of pixels, and a non-uniformity correction unit configured to perform first and second interpolations, the first interpolation for performing a first interpolation, and the second interpolation for performing a second interpolation using index information corresponding to a pixel of the plurality of pixels may be provided.

### CROSS-REFERENCE TO RELATED APPLICATION

This application claims priority under 35 U.S.C. §119 to Korean Patent Application No. 10-2014-0070357 filed on Jun. 10, 2014, the disclosure of which is hereby incorporated by reference in its entirety.

### BACKGROUND

1. Field

Some example embodiments of the inventive concepts relate to display devices, and more particularly, to display devices capable of correcting a mura defect with a reduced calculation and/or a smaller data storage capacity.

2. Description of Related Art

Recently, various types of flat panel displays, for example, a liquid crystal display (LCD), a plasma display panel (PDP), an electroluminescence display panel, etc., have been developed to replace a conventional cathode ray tube (CRT).

In the event that errors occur in any processes of manufacturing the display devices, visible non-uniform regions can be observed while performing a final light-on test of the display devices. These errors can cause problems, such as bad pixels, non-uniform gray scale, the mura phenomenon, etc.

### SUMMARY

Some example embodiments of the inventive concepts provide a display device capable of efficiently correcting a mura defect while reducing an amount of desired correction data.

Example embodiments of the inventive concepts are not limited to the present disclosure and other embodiments may become apparent to those of ordinary skill in the art based on the following descriptions.

In accordance with an example embodiment of the inventive concepts, a display device includes a panel including a plurality of pixels, and a non-uniformity correction unit configured to perform interpolations with respect to different pixels of the plurality of pixels in multiple stages to correct non-uniformity of the pixels.

In some example embodiments, the non-uniformity correction unit may be configured to perform a first interpolation for a pixel having look-up data to provide first interpolated data, and perform a second interpolation for a pixel not having look-up data using the first interpolated data.

In some example embodiments, the non-uniformity correction unit may include a look-up table configured to receive a pixel address and pixel luminance from the panel, and output look-up data, a first interpolation block configured to generate the first interpolated data by performing the first interpolation using the look-up data, and a second interpolation block configured to perform the second interpolation using the first interpolated data.

In some example embodiments, the look-up table may be configured to output the look-up data with respect to some pixels from among the plurality of pixels.

In some example embodiments, the second interpolation block may be configured to perform the second interpolation with respect to a bad pixel using the first interpolated data, the bad pixel being a pixel among the plurality of pixels that does not meet set criteria with regard to at least one display characteristic.

In some example embodiments, the first interpolation block may be configured to perform the first interpolation using at least one of a nearest neighbor interpolation method, a bilinear interpolation method, a median interpolation method, and a brute-force interpolation method.

In some example embodiments, the second interpolation block may be configured to perform the second interpolation using at least one of a nearest neighbor interpolation method, a bilinear interpolation method, a median interpolation method, and a brute-force interpolation method.

In accordance with an example embodiment of the inventive concepts, a display device includes a panel including a plurality of pixels, and a non-uniformity correction unit configured to perform a first interpolation with regard to a first pixel from among the plurality of pixels and a second interpolation with regard to a second pixel from among the plurality of pixels that are not interpolated by the first interpolation, using data interpolated by the first interpolation and index information, the index information being information designating a pixel among the plurality of pixels as a good one or a bad one based on set criteria with regard to at least one display characteristic.

In some example embodiments, the non-uniformity correction unit may be configured to perform the first interpolation with respect to a first pixel, from among the plurality of pixels, having look-up data, and perform the second interpolation with regard to the second pixel, from among the plurality of pixels, not having look-up data using the index information.

In some example embodiments, the non-uniformity correction unit may include a look-up table configured to receive a pixel address and pixel luminance, and output look-up data, a first interpolation block configured to generate first interpolated data by performing the first interpolation using the look-up data, a second interpolation block configured to perform the second interpolation using the first interpolated data and the index information, an index unit configured to provide the index information, and an adder configured to calculate a result from the second interpolation block and the pixel luminance, and output the calculated value as a final expected value.

In some example embodiments, the look-up table may be configured to output look-up data with respect to a select number of pixels, to which look-up data is assigned, the select number being less than a total number of the plurality of pixels.

In some example embodiments, the second interpolation block may be configured to perform the second interpolation with respect to a bad pixel from among the plurality of pixels based on the index information and the first interpolated data, the bad pixel being a pixel among the plurality of pixels that does not meet set criteria with regard to at least one display characteristic.

In some example embodiments, the index unit may be ‘1’ when a pixel is a bad pixel and ‘0’ when the pixel is a good pixel.

In some example embodiments, the first interpolation block may be configured to perform the first interpolation using at least one of a nearest neighbor interpolation method, a bilinear interpolation method, a median interpolation method, and a brute-force interpolation method.

In some example embodiments, the second interpolation block may be configured to perform the second interpolation using a least one of a nearest neighbor interpolation method, a bilinear interpolation method, a median interpolation method, and a brute-force interpolation method.

In accordance with an example embodiment of the inventive concepts, a display device include a panel including a plurality of pixels, and a non-uniformity correction unit for correcting display non-uniformity, the non-uniformity correction unit including a look-up table unit configured to assign look-up data to a select number of pixels from among the plurality of pixels, the select number being less than a total number of the plurality of pixels, a first interpolation unit configured to perform a first interpolation based on the look-up data received from the look-up table unit and generate first interpolated data, and a second interpolation unit configured to perform a second interpolation based on the first interpolated data and generate a corrected display characteristic value.

In some example embodiments, the second interpolation unit may be configured to perform the second interpolation with respect to a bad pixel from among the plurality of pixels based on the first interpolated data and index information, which designate pixels not meeting set criteria with regard to at least one display characteristic among the plurality of pixels as bad pixels.

In some example embodiments, the second interpolation unit may be configured to perform the second interpolation with respect to a pixel, from among the plurality of pixels, not having look-up data using index information, which designate the plurality of pixels in the panel as good pixels or bad pixels based on set criteria with regard to at least one display characteristic.

In some example embodiments, the first interpolation unit may be configured to perform the first interpolation with respect to a pixel, from among the plurality of pixels, having look-up data.

In some example embodiments, the second interpolation unit may be configured to selectively perform the second interpolation with respect to pixels, from among pixels, which are not included in the select number of pixels and are not interpolated by the first interpolation unit.

### BRIEF DESCRIPTION OF THE DRAWINGS

The foregoing and other features and advantages of the inventive concepts will be apparent from the more particular description of some example embodiments of the inventive concepts, as illustrated in the accompanying drawings. Like reference numerals refer to like elements throughout the different the drawings. The drawings are not necessarily to scale, emphasis instead being placed upon illustrating the principles of the inventive concepts. In the drawings:

FIG. 1 is a schematic block diagram showing a conventional display device.

FIG. 2 is a view showing an example of a mura defect caused on a panel;

FIG. 3 is a graph showing an example of luminance non-uniformity according to the mura defect illustrated in FIG. 2;

FIG. 4 is a block diagram showing a display device for correcting non-uniformity in accordance with an example embodiment of the inventive concepts;

FIG. 5 is a schematic block diagram of a mura defect correction unit included in the display device of FIG. 4;

FIG. 6 is a view showing whether look-up data of a panel is present or not in accordance with an example embodiment of the inventive concepts;

FIG. 7 is a view showing an example of pixel index information corresponding to each of the plurality of pixels included in a panel;

FIG. 8 is a flowchart showing an operational flow of a display device for correcting display non-uniformity in accordance with an example embodiment of the inventive concepts;

FIG. 9 is a block diagram showing an example of a computer system including the display device for correcting display non-uniformity as shown in FIG. 4;

FIG. 10 is a block diagram showing an example of a computer system including a display device for correcting non-uniformity as shown in FIG. 4; and

FIG. 11 is a block diagram showing another example of a computer system including a display device for correcting display non-uniformity as shown in FIG. 4.

### DETAILED DESCRIPTION OF EXAMPLE EMBODIMENTS

Hereinafter, some example embodiments of the inventive concepts will be described in detail with reference to the accompanying drawings. In detailed descriptions of the example embodiments of the inventive concepts, detailed descriptions of well-known configurations unrelated to the gist of the inventive concepts will be omitted.

Particular structural or functional descriptions disclosed in this specification are only for the purpose of description of the example embodiments of the inventive concepts. Example embodiments of the inventive concepts may have various modifications in form and are not limited to the example embodiments disclosed herein.

While example embodiments of the inventive concepts are susceptible to various modifications and alternative forms, a few example embodiments disclosed herein are shown by way of example in the drawings and will herein be described in detail. It should be understood, however, that there is no intent to limit example embodiments of the inventive concepts to the particular forms disclosed. On the contrary, example embodiments are to cover all modifications, equivalents, and alternatives falling within the spirit and scope of the inventive concepts.

It will be understood that, although the terms “first,” “second,” etc. may be used herein to describe various elements, these elements should not be limited by these terms. These terms are used to distinguish one element from another. For example, a first element could be termed a second element, and similarly, a second element could be termed a first element, without departing from the teachings of example embodiments of the inventive concepts.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion, that is, “between” versus “directly between,” adjacent” versus “directly adjacent,” etc. Expressions such as “at least one of,” when preceding a list of elements, modify the entire list of elements and do not modify the individual elements of the list.

The terminology used herein is for the purpose of describing particular example embodiments only and is not intended to be limiting of example embodiments of the present inventive concepts. As used herein, the singular forms “a,” “an,” and “the” are intended to include the plural forms as well, unless the context clearly indicates otherwise. It will be further understood that the terms “comprises,” “comprising,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof

Unless otherwise defined, all terms (including technical and scientific terms) used herein have the same meaning as commonly understood by one of ordinary skill in the art to which example embodiments of this inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Meanwhile, when example embodiments can be implemented differently, functions or operations of certain example embodiments may occur in a different way from a flow described in the flowchart according to the present example embodiments. For example, two consecutive operations or function may be performed simultaneously, or some operations or functions may be performed in a reverse order.

The term such as “ . . . unit” in this description indicates a unit processing at least one function or performing at least one operation and may be implemented by hardware or software or a combination of hardware and software.

Hereinafter, some example embodiments of the inventive concepts will be described in detail with reference to the accompanying drawings.

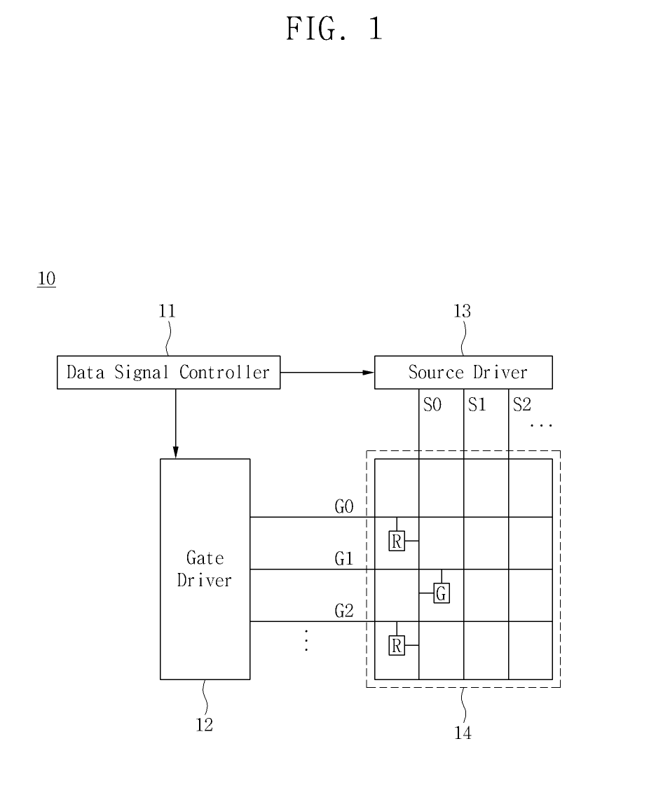

FIG. 1 is a schematic block diagram showing a conventional display device 10.

Referring to FIG. 1, the display device 10 may include a data signal controller 11, a gate driver 12, a source driver 13, and a panel 14.

First, the data signal controller 11 receives image data and a control signal from the outside, and controls operations of the gate driver 12 and the source driver 13. The data signal controller 11 may provide a gate driving signal (not shown) and a source driving signal (not shown) as conventional control signals to the gate driver 12 and the source driver 13, respectively, and control operations thereof

The gate driver 12 may sequentially apply gate turn-on voltages to gate lines GO to G2 included in the panel 14. The gate driver 12 may be turned on or off to apply a gray-scale voltage to a transistor included in a desired pixel.

The source driver 13 may be controlled by the data signal controller 11, and may provide source data (e.g., pixel data R, G, and B) to source lines SO to S2 of the panel 14. Thus, the source driver 13 may control displaying full colors through a combination of red R, green G, and blue B pixels.

The panel 14 may include liquid crystal cells arranged in a matrix form at intersections of the gate lines GO to G2 and the source lines SO to S2. As described above, when a driving signal is applied to one gate line by the gate driver 12, switches (not shown) connected to the gate lines GO to G2 may be turned on. Source data applied to the source lines SO to S2 from the source driver 13 may be transferred to pixel electrodes (see R and G) corresponding to the switches turned on by the gate driver 12, through the switches. An orientation state of liquid crystal of the liquid crystal cell (not shown) is changed by electric fields applied to the pixel electrodes (see R and G), and thus images are displayed. Although a plurality of source lines SO to S2 and a plurality of gate lines GO to G2 are illustrated for convenience of description, example embodiments are not limited thereto.

The display device 10, which is supposed to display the same color in terms of a color characteristic, an electrical characteristic, an optical characteristic, etc., may display different colors depending on locations when the pixels have different electrical or optical characteristics to each other due to an error or a failure during a manufacturing process.

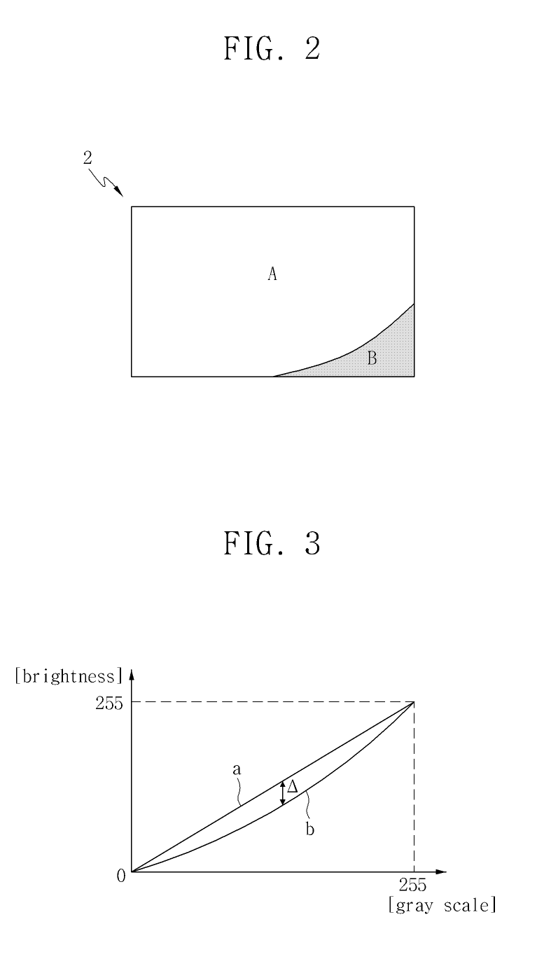

FIG. 2 is a view showing an example of a mura defect caused on a panel.

Referring to FIG. 2, a region A in the panel 2 is relatively bright, and a region B is relatively dark.

Even though a display device is set to display the same color in the panel 2, the display device fails to display on the panel with the same luminance and chromaticity. This display non-uniformity as shown in FIG. 2 may occur due to a problem during a manufacturing process.

The display non-uniformity (instead of the expected display uniformity) occurring in the panel 2 due to a change of luminance with respect to respective pixels of the panel 2 is referred to as a mura defect.

There are various mura phenomena in addition to the example shown in FIG. 2. For example, there may be line mura, black mura, white spot mura, ring mura, etc.

FIG. 3 is a graph showing example luminance non-uniformity according to the mura defect illustrated in FIG. 2.

Referring to FIG. 3, an output characteristic b deviates from an input characteristic a.

An X-axis of the graph shown in FIG. 3 represents a gray scale, and a Y-axis thereof represents brightness. Both of the gray scale and the brightness respectively include all bits in a range of 0 to 255.

Referring to FIG. 3, the output characteristic b does not have linearity compared to the input characteristic a of the panel. Thus, a difference A between two characteristics is caused.

The difference Δ means that the display device has non-uniformity. Because luminance and chromaticity of a color appear differently in a real display device, the display device may exhibit a change of color. Thus, such a display non-uniformity (e.g., a mura defect) may cause an error when high image quality and accurate colors are displayed.

To address the display non-uniformity, a method of performing an interpolation using a look-up table may be used. However, this method tends to lead to increased processing time due to increased data in an interpolation process and excessive data storage capacity requirements to store interpolated data. Thus, utility of the current look-up table based interpolation method may be substantially constrained as a size of the panel increases.

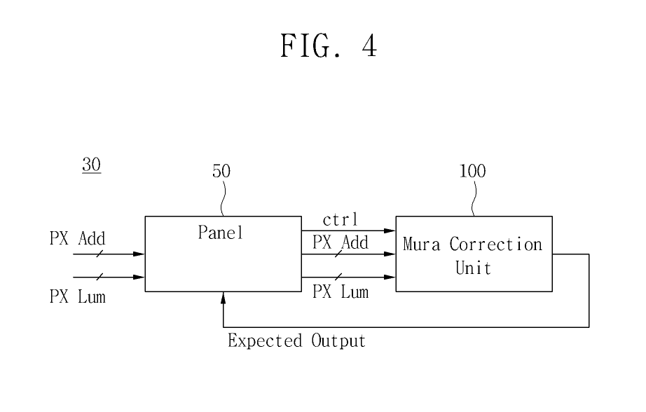

FIG. 4 is a block diagram showing a display device for correcting non-uniformity in accordance with an example embodiment of the inventive concepts.

Referring to FIG. 4, a display device 30 for correcting non-uniformity includes a panel 50 and a mura correction unit 100.

The panel 50 receives control signals (e.g., a pixel address PX Add and pixel luminance PX Lum) configured to control pixels from the outside. When a corresponding pixel is selected by the pixel address PX Add, the pixel is activated in the panel 50 to emit light, and the image is displayed according to a degree of the pixel luminance PX Lum. Here, when a luminance error occurs in the display device 30, the panel 50 provides a correction control signal ctrl to the mura correction unit 100.

The mura correction unit 100 may be controlled by the correction control signal ctrl, receive the pixel address PX Add and the pixel luminance PX Lum, and be configured to correct non-uniformity for the panel 50 in multiple stages.

The mura correction unit 100 in accordance with some example embodiments of the inventive concepts may perform an interpolation in two stages. The mura correction unit 100 in accordance with some example embodiments of the inventive concepts may perform an interpolation using pixel index information. The mura correction unit 100 in accordance with some example embodiments of the inventive concepts may perform a first interpolation with respect to a pixel having look-up data, and provide first interpolated data.

Further, the mura correction unit 100 may determine whether the pixel is good or bad with respect to a pixel that has not experienced the first interpolation, and performs a second interpolation with respect to a bad pixel using the first interpolated data.

Thus, the mura correction unit 100 may yield a result value to be used to correct non-uniformity (e.g., an expected output) to the panel 50, as a feedback. Thus, when a non-uniformity phenomenon of the panel 50 occurs, the luminance error of the panel 50 may be corrected, thereby improving the non-uniformity characteristic of the panel.

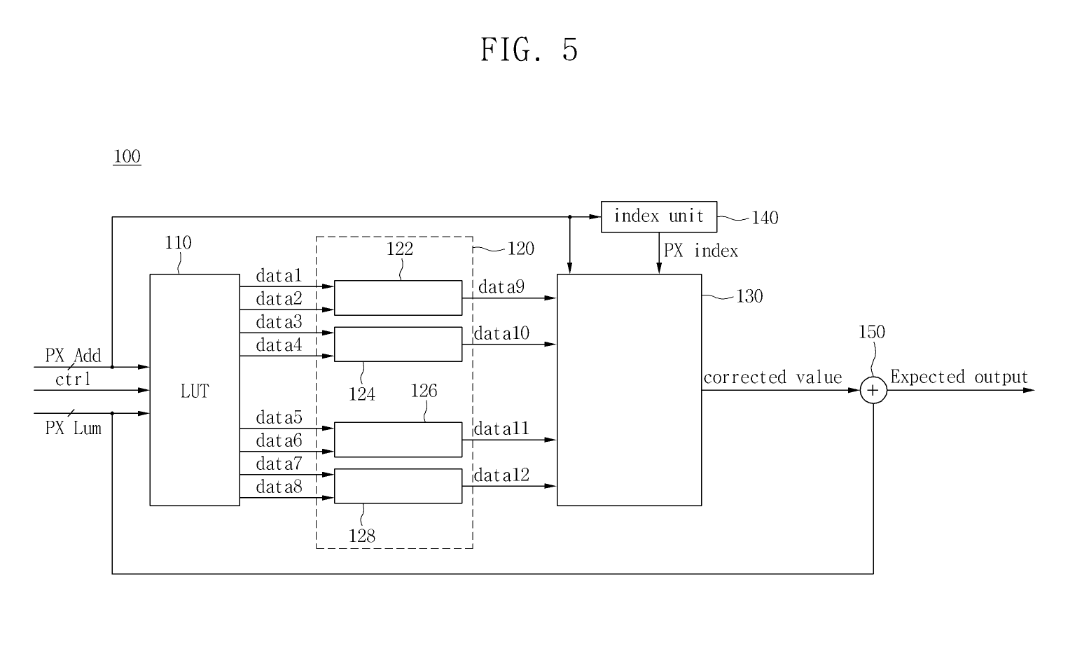

Configurations and operations of the mura correction unit 100 will be described in detail with reference to FIG. 5.

FIG. 5 is a schematic block diagram of the mura defect correction unit included in the display device of FIG. 4.

Referring to FIG. 5, a mura correction unit 100 includes a look-up table (LUT) 110, a first interpolation block 120, a second interpolation block 130, an index unit 140, and an adder 150.

The LUT 110 receives a pixel address PX Add and pixel luminance PX Lum, and outputs a plurality of look-up data data1 to data8. Here, the look-up data may indicate data representing a degree of mura correction. Therefore, each of the look-up data data1 to data8 shows as one data for convenience of description, but each of the look-up data may each have a set of data including in a range of 0 to 255 bits.

For example, when non-uniformity occurs, and an expected luminance information of a pixel is referred to as “R” and a current luminance information is referred to as “R,” the look-up data stores data “C,” which corresponds to and is used to correct a difference between the current and expected luminance information (see Equation 1).

R′=R+C [Equation 1]

As shown in Equation 1, the difference between these two information may be stored in the LUT 110 as mura correction information.

The LUT 110 in accordance with the present example embodiment of the inventive concepts may assign the look-up data to predetermined (or alternatively, desired or a select number of) pixels instead of assigning the look-up data to all pixels.

Due to the characteristics of an LCD panel, a brightness change of an image gradually occurs in a region in which a mura defect is caused. Therefore, adjacent pixels may have similar brightness characteristics. Based on the LCD characteristics, an interpolation is performed using luminance data of the adjacent pixels in the example embodiment of the inventive concepts.

For example, the display device can be configured such that one pixel per each two pixels has one piece of the look-up data. Although, eight pieces of the look-up data (e.g., data1 to data8) are illustrated in the drawing, the number of the look-up data is not limited thereto and may be changed according to an intention of a designer.

Therefore, the LUT 110 may provide eight pieces of the look-up data, and the first interpolation block 120 may generate four pieces of first interpolated data data9 to data12 with respect to eight pieces of the look-up data.

The number of data provided by the LUT 110 may change according to interpolation schemes and/or methods.

The LUT 110 may store a mura luminance variation or an amount of mura correction of image data, or an equation capable of compensating for a mura defect. Here, the LUT storing the amount of mura correction is explained as an example. The LUT 110 may be formed of any one among a programmable read only memory (PROM), an erasable PROM (EPROM), an electrically erasable (EEPROM), a flash memory, and a static random access memory (SRAM), or any memory equivalents thereof.

The first interpolation block 120 may perform a first interpolation using look-up data received from the LUT 110. The first interpolation block 120 may provide first interpolated data data9 to data12. The first interpolation block 120 may include a plurality of interpolation units 122, 124, 126, and 128. Each of the interpolation units 122, 124, 126, and 128 may perform an interpolation on respective subset of the received look-up data data1 to data8. The above described data1 and data2 indicate look-up data of a corresponding subset of pixels, and the numbers 1 and 2 included in the name do not have any meanings

A first interpolation unit 122 may perform an interpolation on a first look-up data data1 and a second look-up data data2.

A second interpolation unit 124 may perform an interpolation on a third look-up data data3 and a fourth look-up data data4.

Likewise, a third interpolation unit 126 and a fourth interpolation unit 128 may perform interpolations using corresponding subsets of received look-up data, respectively.

Thus, each of the interpolation units 122, 124, 126, and 128 may perform respective interpolations using the look-up data (e.g., mura correction data), and provide the first interpolated data data9 to data12.

For example, each of the interpolation units 122, 124, 126, and 128 may perform a first interpolation using a nearest neighbor interpolation method. However, interpolation methods according to example embodiments are not limited thereto.

The second interpolation block 130 may perform a second interpolation using the first interpolated data data9 to data12, the pixel address PX Add, and pixel index information PX index.

The second interpolation block 130 may selectively perform an interpolation with regard to select pixels, on which an interpolation is desired, from among non-interpolated pixels, using the pixel index information PX index. For example, the second interpolation block 130 may perform the interpolation for the select pixels from among the non-interpolated pixels, on which an interpolation is desired, using the first interpolated data data9 to data12, and provide a corrected value to the adder 150.

The first interpolation block 120 including the first to fourth interpolation units 122, 124, 126, 128, and the second interpolation block 130 may be implemented by a processor. For example, the processor may be an arithmetic logic unit, a digital signal processor, a microcomputer, a field programmable array, a programmable logic unit, a microprocessor or any other device capable of responding to and executing instructions in a defined manner such that the processor is programmed with instructions that configure the processing device as a special purpose computer to perform the aforementioned first and second interpolations. The instructions may be stored on a non-transitory computer readable medium. Examples of non-transitory computer-readable media include hardware devices that are specially configured to store and perform program instructions, such as read-only memory (ROM), random access memory (RAM), flash memory, and the like. The non-transitory computer-readable media may also be a distributed network, so that the program instructions are stored and executed in a distributed fashion. The program instructions may be executed by one or more processors.

The index unit 140 may store the pixel index information PX index, and provide the pixel index information PX index to the second interpolation block 130. The pixel index information PX index may be obtained from the LUT 110, and may include information as to whether a pixel is a a good one or a bad one based on set criteria with regard to display characteristic values (e.g., luminance, chromaticity, etc.). The bad pixel may be a pixel that does not meet desired set criteria with regard to at least one display characteristic value. For example, the pixel index information PX index for a bad pixel can be stored as ‘1’ and the second interpolation block 130 may perform the interpolation with regard to the bad pixel.

The index unit 140 may be implemented by a processor. For example, the processor may be an arithmetic logic unit, a digital signal processor, a microcomputer, a field programmable array, a programmable logic unit, a microprocessor or any other device capable of responding to and executing instructions in a defined manner such that the processor is programmed with instructions that configure the processing device as a special purpose computer to store the pixel index information PX index, and provide the pixel index information PX index to the second interpolation block 130. The instructions may be stored on a non-transitory computer readable medium. Examples of non-transitory computer-readable media include hardware devices that are specially configured to store and perform program instructions, such as read-only memory (ROM), random access memory (RAM), flash memory, and the like. The non-transitory computer-readable media may also be a distributed network, so that the program instructions are stored and executed in a distributed fashion. The program instructions may be executed by one or more processors.

The adder 150 may add, for example, the original pixel luminance PX Lum to the corrected value provided from the second interpolation block 130, and provide a calculated value as a final expected output. In other words, as described in Equation 1, the adder 150 may add the corrected value to the pixel luminance PX Lum so that the expected output is provided as expected luminance information. As shown in FIG. 4, the expected output (e.g., a final corrected value) may be provided to the panel 50 as a feedback.

Operations of the non-uniformity correction unit 100 for correcting non-uniformity in accordance with some example embodiments of the inventive concepts will be described in detail.

As described above, first interpolation blocks 120 in accordance with example embodiments are not limited to a specific interpolation method, so long as the interpolation blocks are configured to perform an interpolation with regard to look-up data, which are assigned to select pixels (instead of being assigned to all pixels).

Conventionally, an amount of memory for storing the LUT 110 per one pixel may be determined by the following Equation.

LUT size=image width*image height*3colors*look-up data assigned per one pixel [Equation 2]

Therefore, in the case of a full color display (e.g., FHD), the LUT size becomes 1920*1080*3*8 according to Equation 2. Thus, a storage capacity for storing the LUT of the full color display may be 48 Mbytes.

In the case of an ultra display (UD) having an extremely high image quality exceeding the above full color display, the LUT size is much greater than the full color display. Thus, a storage capacity for storing the LUT of the ultra display may be 768 Mbytes (e.g., (1920*4)*(1080*4)*3*8).

Therefore, a burden for the data capacity of the LUT may increase. Accordingly, a calculation time relating to look-up data stored in the LUT 110 may also increase.

According to some example embodiments of the inventive concepts, pixels having the look-up data may be selectively set. Therefore, the first interpolation block 120 may perform a first interpolation with respect to the pixels having the set look-up data data1 to data8 and generate first interpolated data data9 to data12.

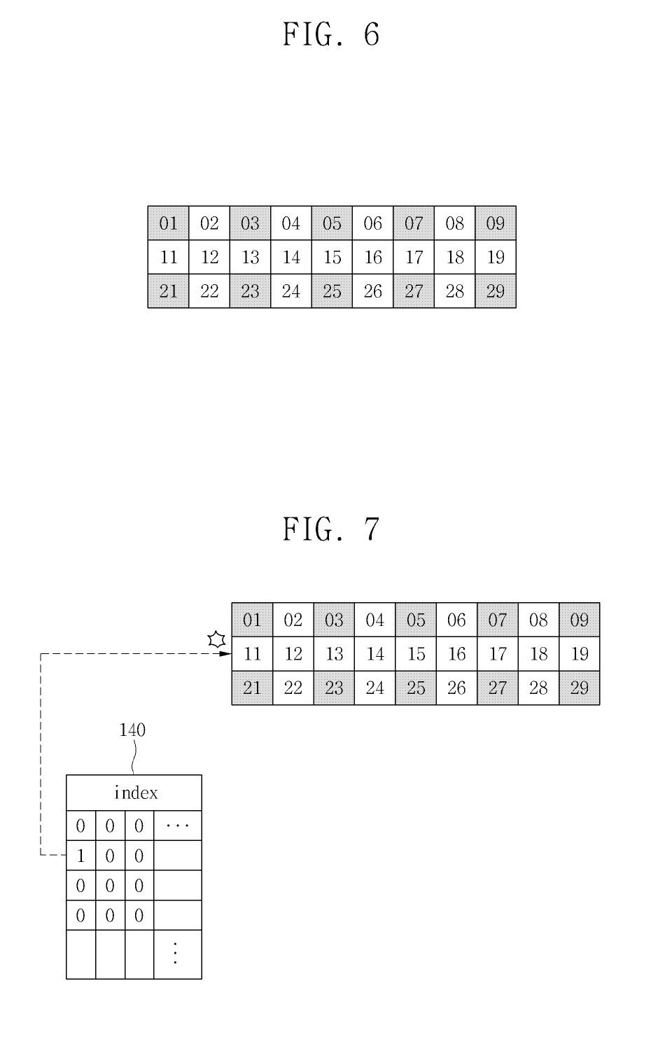

FIG. 6 is a view showing whether look-up data of the panel 50 is present or not in accordance with an example embodiment of the inventive concepts.

Referring to FIG. 6, a plurality of pixels may be present in the panel 50. In FIG. 6, shaded pixels designate pixels to which look-up data are assigned, and unshaded pixels designate pixels to which look-up data are not assigned.

Here, the first interpolation block 120 in accordance with some example embodiments of the inventive concepts may perform a first interpolation for the colored pixels to which the look-up data are assigned.

For example, the first interpolation unit 122 may perform the first interpolation for pixels 01 and 03 using a nearest neighbor interpolation method. Because when non-uniformity is corrected, the first interpolation unit 122 performs a first interpolation with respect to some pixels (e.g., pixels 01 and 03) to which look-up data (stored in the LUT 110) are assigned, a total amount of look-up data may be reduced.

Meanwhile, although the nearest neighbor interpolation method is described as one example of interpolation methods for convenience of description, example embodiments are not limited thereto. Various interpolation methods, for example, a bilinear interpolation method, a median interpolation method, a brute-force interpolation method, etc., may be used.

According to some example embodiments of the inventive concepts, the first interpolation block 120 may not perform an interpolation with regard to all pixels. For example, look-up data may be assigned to one pixel per two pixels, and a first interpolation may be performed on the pixels to which the look-up data are assigned. Therefore, a storage capacity of the look-up data and a calculation burden relating thereto may be reduced.

For example, the look-up data may be assigned to select number of pixels in an intermittent or regular pattern. The first interpolation block 120 may not perform an interpolation in various ways taking into consideration a compromise of calculation accuracy and a hardware cost. According to the method described above, the look-up data may be assigned to one pixel per two pixels. Accordingly, a storage capacity for storing the look-up table 110 is reduced to half (e.g., 50%) compared to a storage capacity for storing conventional look-up data. In the event that the first interpolation block 120 performs an interpolation based on the look-up data assigned to one pixel per four pixels, a storage capacity for storing the look-up table 110 is reduced to one fourth (e.g., 25%) compared to a storage capacity for storing conventional look-up data.

The second interpolation block 130 in accordance with some example embodiment of the inventive concepts may perform a second interpolation using the pixel address PX Add, the pixel index information PX index, and the first interpolated data data9 to data12.

For example, the pixel index information PX index may be information about whether the pixel is good or bad. The second interpolation block 130 may identify statuses of pixels (e.g., ‘good’ or ‘bad’) using the pixel address PX Add and the pixel index information PX index. Further, the second interpolation block 130 may be configured to not perform an interpolation with regard to a good pixel.

The second interpolation block 130 may perform an interpolation using the interpolated data of the pixel (e.g., the first interpolated data data9 to data12). As described above, when the pixel index information PX index can be used to reduce a calculation burden of the interpolated data, a calculation error may be prevented or reduced while performing the interpolation. Because the second interpolation block 130 is configured to not perform an interpolation with regard to pixels, on which the interpolation is not desired, a correction error and a correction calculation burden may be reduced.

FIG. 7 is a view showing an example of pixel index information corresponding to each of the plurality of pixels included in a panel.

For example, a pixel of position 11 among pixels in the panel 50 may be a bad pixel, and pixels having interpolated data generated by the first interpolation block 120 may be pixels of positions 01, 03, 05, 07, 09, 21, 23, 25, 27, and 29.

In order to correct the pixel of position 11 according to the pixel index information PX index of the index unit 140, the second interpolation block 130 may perform an interpolation for the pixel using nearest look-up data of position 11. That is, in order to correct the pixel of position 11, the second interpolation block 130 may perform a second interpolation for the pixel of position 11 using the pixels of positions 01 and 21. For example, a bilinear interpolation method may be used as a method for the second interpolation. However, methods for the second interpolation are not limited thereto. For example, a spatial interpolation method, which is performed on a desired (or alternatively, predetermined) region, may be used as a method for the second interpolation.

Therefore, according to some example embodiments of the inventive concepts, the first interpolation is performed on the pixels having the look-up data. The number of the look-up data is set within a desired (or alternatively, predetermined) number per a desired (or alternatively, predetermined) region of the panel to reduce a burden of performing calculations with regard to look-up data assigned to all pixels and a burden of providing a memory having sufficient size for storing the look-up data. Then, the second interpolation may be performed on bad pixels using the pixel index information PX index of the index unit 140 and the first interpolated data data9 to data12. Therefore, the number of look-up data and a calculation time relating to the same may be reduced. Further massive calculations and calculation errors may be prevented or reduced.

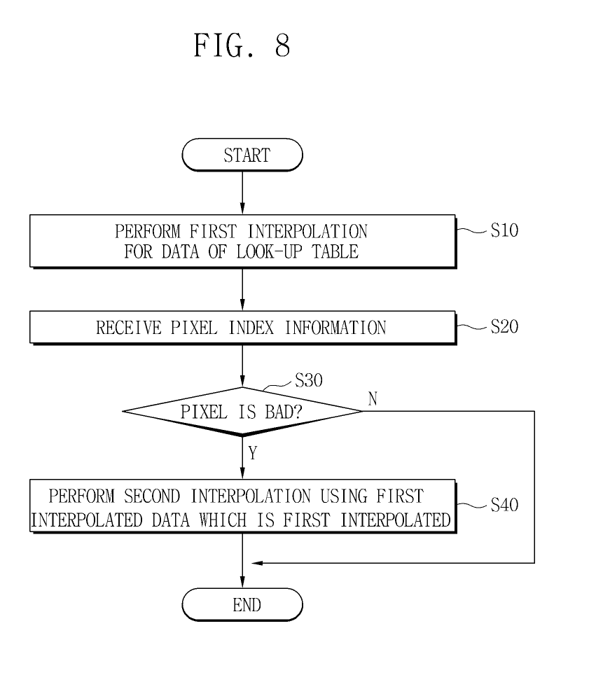

FIG. 8 is a flowchart showing an operational flow of the display device for correcting display non-uniformity in accordance with an example embodiment of the inventive concepts.

The operations of the display device 30 for correcting display non-uniformity will be described with reference to FIGS. 4, 5, and 8.

A first interpolation may be performed with respect to look-up data from a LUT (S10).

The look-up data from the LUT may correspond to a select number of desired (or alternatively, predetermined) pixels. The first interpolation may be performed with regard to pixels to which look-up data are assigned (these pixels being adjacent to pixels to which look-up data are not assigned), and may generate first interpolated data data9 to data12.

Subsequently, pixel index information PX index may be received (S20).

The pixel index information PX index may be information as to whether the pixel is a good one or a bad one, and a second interpolation may be controlled to not perform an interpolation with respect to a good pixel based on the pixel index information PX index (S30).

When a pixel is determined to be a bad pixel, ‘1’ may be assigned as a value of the pixel index information PX index, and a second interpolation may be performed with regard to this bad pixel using the first interpolated data generated by the first interpolation (S40).

When a pixel is determined to be a good pixel, ‘0’ (N) may be assigned as a value of the pixel index information PX index, a second interpolation may not be performed with regard to this good pixel and the operation ends.

As described above, because the display device 30 in accordance with some example embodiments of the inventive concepts sequentially performs first and second interpolations to correct mura defects (e.g., non-uniformity defects), a total amount of look-up data may be reduced. Because the first interpolation is performed on a select number of pixels, to which look-up data are assigned, and the second interpolation is performed on bad pixels, from among pixels not interpolated by the first interpolation using the first interpolated data, efficiency of the interpolation may be improved.

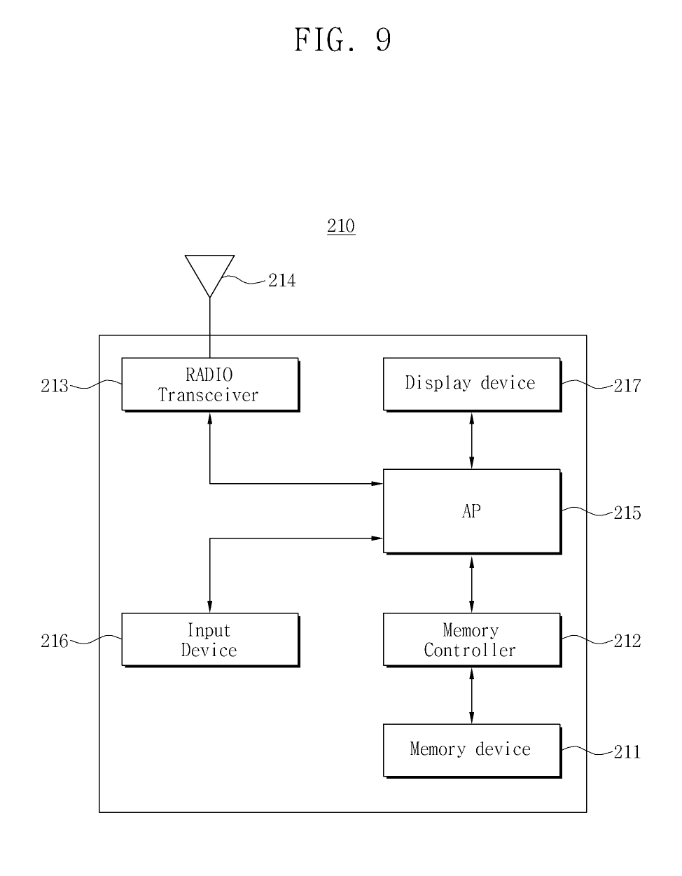

FIG. 9 is a block diagram showing an example of a computer system including the display device for correcting display non-uniformity as shown in FIG. 4.

Referring to FIG. 9, an computer system 210 includes a memory device 211, a memory controller 212 configured to control the memory device 211, a radio transceiver 213, an antenna 214, an application processor (AP) 215, an input device 216, and a display device 217.

The radio transceiver 213 may transmit or receive radio signals through the antenna 214. For example, the radio transceiver 213 may convert a radio signal received through the antenna 214 into a signal which may be processed in the AP 215.

The AP 215 may process a signal output from the radio transceiver 213, and transmit a processed signal to the display device 217. Further, the radio transceiver 213 may convert a signal output from the AP 215 into a radio signal, and output the converted radio signal to an external device through the antenna 214.

The input device 216 may be a device at which a control signal for controlling an operation of the AP 215, or data to be processed by the AP 215 may be input. For example, the input device 216 may be implemented as a pointing device, for example, a touch pad or a computer mouse, a keypad, or a keyboard.

According to some example embodiments, the memory controller 212 configured to control an operation of the memory device 211 may be implemented, for example, as a part of the AP 215, or as a chip separated from the AP 215.

According to some example embodiments, the display device 217 may be implemented as, for example, the display device 30 shown in FIG. 4.

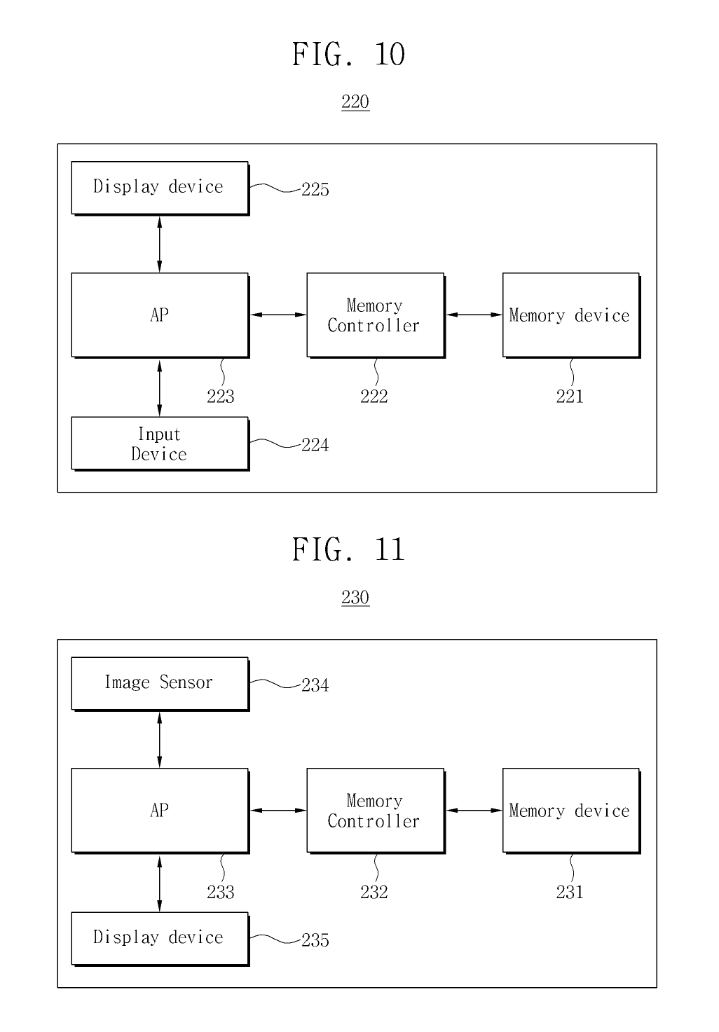

FIG. 10 is a block diagram showing an example of a computer system including the display device for correcting display non-uniformity as shown in FIG. 4.

Referring to FIG. 10, a computer system 220 may be implemented as, for example, a personal computer (PC), a network server, a tablet PC, a net-book, an e-reader, a personal digital assistant (PDA), a portable multimedia player (PMP), a MP3 player, or a MP4 player.

According to the present example embodiment, the computer system 220 includes a memory device 221, a memory controller 222 configured to process data from the memory device 221, an AP 223, an input device 224, and a display device 225.

When data is input from the input device 224 and stored in the memory device 221, the AP 223 may cause display of the data or processed data through the display device 225. For example, the input device 224 may be implemented as a pointing device, for example, a touch pad or a computer mouse, a keypad, or a keyboard. The AP 223 may control overall operations of the computer system 220, and control an operation of the memory controller 222.

According to some example embodiments, the memory controller 222 configured to processing data from the memory device 221 may be implemented, for example, as a part of the AP 223, or as a chip separated from the AP 223.

According to some example embodiments, the display device 225 may be implemented as, for example, the display device 30 shown in FIG. 4.

FIG. 11 is a block diagram showing another example of a computer system including a display device for correcting display non-uniformity as shown in FIG. 4.

Referring to FIG. 11, a computer system 230 may be implemented as an image process device, for example, a digital camera, or a mobile phone, a smart phone, or a tablet, in which the digital camera is mounted.

The computer system 230 includes a memory device 231, a memory controller 232 configured to control a data process operation, for example, a write operation or a read operation of the memory device 231. Further, the computer system 230 includes an AP 233, an image sensor 234, and a display device 235.

The image sensor 234 of the computer system 230 may convert an optical image to digital signals, and the converted digital signals may be transmitted to the AP 233 and/or the memory controller 232. The converted digital signals may be displayed on the display device 235, or may be stored in the memory device 231 through the memory controller 232, according to a control of the AP 233.

Further, data stored in the memory device 231 may be displayed on the display device 235 according to a control of the AP 233 or the memory controller 232.

According to some example embodiments, the memory controller 232 configured to control an operation of the memory device 231 may be implemented, for example, as a part of the AP 233, or as a chip separated from the AP 233.

According to some example embodiments, the display device 235 may be implemented by, for example, the display device 30 shown in FIG. 4.

Because the display device in accordance with some example embodiments of the inventive concepts assigns look-up data to a select number (or alternatively, a desired number or a predetermined number) of pixels, and sequentially performs first and second interpolations, a data storage capacity of the look-up data and a calculation burden can be reduced.

Some example embodiments of the inventive concept relate to a memory device, and more particularly, to a display device including the same.

While the foregoing example embodiments of the inventive concepts have been described in detail, it should be understood that various changes, substitutions and alterations may be made herein without departing from the scope of example embodiments of the inventive concepts as defined by the following claims.

The foregoing is illustrative of various example embodiments and is not to be construed as limiting thereof. Although a few example embodiments have been described, those skilled in the art will readily appreciate that many modifications are possible in example embodiments without materially departing from the novel teachings and advantages. Accordingly, all such modifications are intended to be included within the scope of example embodiments of the inventive concepts as defined in the claims. In the claims, means-plus-function clauses are intended to cover the structures described herein as performing the recited function, and not only structural equivalents but also equivalent structures.

What is claimed is:

1. A display device, comprising:
a panel including a plurality of pixels; and
a non-uniformity correction unit configured to perform interpolations with respect to different pixels of the plurality of pixels in multiple stages.

2. The device according to claim 1, wherein the non-uniformity correction unit is configured to perform a first interpolation for a pixel having look-up data to provide first interpolated data, and perform a second interpolation for a pixel not having look-up data using the first interpolated data.

3. The device according to claim 2, wherein the non-uniformity correction unit comprises:
a look-up table configured to receive a pixel address and pixel luminance from the panel, and output look-up data;
a first interpolation block configured to generate the first interpolated data by performing the first interpolation using the look-up data; and
a second interpolation block configured to perform the second interpolation using the first interpolated data.

4. The device according to claim 3, wherein the look-up table is configured to output the look-up data with respect to some pixels from among the plurality of pixels.

5. The device according to claim 3, wherein the second interpolation block is configured to perform the second interpolation with respect to a bad pixel using the first interpolated data, the bad pixel being a pixel among the plurality of pixels that does not meet set criteria with regard to at least one display characteristic.

6. The device according to claim 3, wherein the first interpolation block is configured to perform the first interpolation using at least one of a nearest neighbor interpolation method, a bilinear interpolation method, a median interpolation method, and a brute-force interpolation method.

7. The device according to claim 3, wherein the second interpolation block is configured to perform the second interpolation using at least one of a nearest neighbor interpolation method, a bilinear interpolation method, a median interpolation method, and a brute-force interpolation method.

8. A display device, comprising:
a panel including a plurality of pixels; and
a non-uniformity correction unit configured to perform
a first interpolation with regard to a first pixel from among the plurality of pixels, and
a second interpolation with regard to a second pixel from among the plurality of pixels that are not interpolated by the first interpolation, using data interpolated by the first interpolation and index information, the index information being information designating a pixel among the plurality of pixels as a good one or a bad one based on set criteria with regard to at least one display characteristic.

9. The device according to claim 8, wherein the non-uniformity correction unit is configured to perform the first interpolation with respect to the first pixel, from among the plurality of pixels, having look-up data, and perform the second interpolation with respect to the second pixel, from among the plurality of pixels, not having look-up data using the index information.

10. The device according to claim 9, wherein the non-uniformity correction unit comprises:
a look-up table configured to receive a pixel address and pixel luminance, and output look-up data;
a first interpolation block configured to generate first interpolated data by performing the first interpolation using the look-up data;
a second interpolation block configured to perform the second interpolation using the first interpolated data and the index information;
an index unit configured to provide the index information; and
an adder configured to calculate a result from the second interpolation block and the pixel luminance, and output the calculated value as a final expected value.

11. The device according to claim 10, wherein the look-up table is configured to output look-up data with respect to a select number of pixels, to which look-up data is assigned, the select number being less than a total number of the plurality of pixels.

12. The device according to claim 10, wherein the second interpolation block is configured to perform the second interpolation with respect to a bad pixel from among the plurality of pixels based on the index information and the first interpolated data, the bad pixel being a pixel among the plurality of pixels that does not meet set criteria with regard to at least one display characteristic.

13. The device according to claim 10, wherein the index information is ‘1’ when a pixel is a bad pixel and ‘0’ when the pixel is in a good pixel.

14. The device according to claim 10, wherein the first interpolation block is configured to perform the first interpolation using at least one of a nearest neighbor interpolation method, a bilinear interpolation method, a median interpolation method, and a brute-force interpolation method.

15. The device according to claim 10, wherein the second interpolation block is configured to perform the second interpolation using at least one of a nearest neighbor interpolation method, a bilinear interpolation method, a median interpolation method, and a brute-force interpolation method.

16. A display device, comprising:
a panel including a plurality of pixels; and
a non-uniformity correction unit for correcting display non-uniformity, the non-uniformity correction unit including,
a look-up table unit configured to assign look-up data to a select number of pixels from among the plurality of pixels, the select number being less than a total number of the plurality of pixels,
a first interpolation unit configured to perform a first interpolation based on the look-up data received from the look-up table unit and generate first interpolated data, and
a second interpolation unit configured to perform a second interpolation based on the first interpolated data and generate a corrected display characteristic value.

17. The display device of claim 16, wherein the second interpolation unit is configured to perform the second interpolation with respect to a bad pixel from among the plurality of pixels based on the first interpolated data and index information, the index information designating pixels not meeting set criteria with regard to at least one display characteristic among the plurality of pixels as bad pixels.

18. The display device of claim 16, wherein the second interpolation unit is configured to perform the second interpolation with respect to a pixel, from among the plurality of pixels, not having look-up data using index information, which designate the plurality of pixels in the panel as good pixels or bad pixels based on set criteria with regard to at least one display characteristic.

19. The display device of claim 18, wherein the first interpolation unit is configured to perform the first interpolation with respect to a pixel, from among the plurality of pixels, having look-up data.

20. The display device of claim 19, wherein the second interpolation unit is configured to selectively perform the second interpolation with respect to pixels, from among pixels, which are not included in the select number of pixels and are not interpolated by the first interpolation unit.
